(19) United States
(12) Patent Application Publication
(10) Pub. No.: US 2026/0289665 A1
(43) Pub. Date: Sep. 24, 2026

(54) FINANCIAL HEALTH DIAGNOSTIC SYSTEM AND METHOD THEREOF

(71) Applicant: Alfred Kwesi Fynn, MANSFIELD (GB)

(72) Inventor: Alfred Kwesi Fynn, MANSFIELD (GB)

(21) Appl. No.: 19/431,833

(22) Filed: Dec. 23, 2025

Related U.S. Application Data
(60) Provisional application No. 63/750,615, filed on Jan. 28, 2025.

(51) Int. Cl. G06Q 40/03; G06F 21/62; G06Q 40/06

(52) U.S. Cl. CPC G06Q 40/033; G06F 21/6245; G06Q 40/066; G06F 2221/2141

(57) ABSTRACT

Disclosed is a computer system and/or method for generating a personal financial health index which may include receiving a country selection and/or data input mode. Financial data associated with a user may be aggregated and/or categorized into input categories, which may include income, spending, debt repayment, and/or assets. Values may be transformed to resolve computational errors by identifying zero denominators and/or adjusting upper and/or lower values. The data may be adjusted based on country-specific variables to reflect a socio-economic environment. Factor inputs may be transformed by matching the adjusted data against one another. Dynamic weights may be generated by modeling interactions between the input categories and/or determining deviation values from benchmarks. The factor inputs and/or dynamic weights may be transformed to determine a personal financial health index value for display via a multimedia interface.

### TECHNICAL FIELD

The present disclosure relates to systems and/or methods which can be used to assess consumer financial health on a national and/or global scale. More specifically, it relates to systems and/or methods for calculating a standardized financial health index by evaluating financial indicators against variable economic and/or geographic parameters.

### BACKGROUND

Consumer financial health may have become a subject of interest for international bodies, such as the United Nations and/or the World Bank, and/or advanced economies. Although a body of literature regarding consumer finance and/or research may exist, practical standard frameworks for assessing consumer financial health for national and/or global use may be absent.

Current methods for assessing financial health may include survey-based tools, such as the Global Findex, which may be used by world organizations. These tools may include questions regarding how a person feels and/or thinks about their finances. Such approaches may be highly subjective, susceptible to biases, difficult to standardize, and/or costly to implement. Furthermore, survey-based financial health tools may not be executed in real-time, may reach limited sample size populations, and/or can result in ambiguities due to wording and/or interpretations. The design, collation, and/or analysis of such results may be complex, potentially producing inaccurate responses from participants. These tools may also be intrusive, which may result in lower participation and/or require incentives to attract participants.

A further limitation of survey-based tools may be the difficulty in accurately quantifying results. For example, if consumers are asked whether they are spending more or less of their income, the definition of “more” or “less” may differ for every responding participant and/or may result in inaccurate classification of results.

Other financial health tools assessing quantitative data may lack global applicability. To explain, challenges may include a failure to account for the interactions and/or interrelationships of indicators of consumer financial health, which can skew final results. Existing quantitative models may also fail to account for macro-economic factors. Practical models capable of assessing the complex interactions between consumer financial behaviors and/or the general economic environment of a country, in granular detail at the household level, may not exist.

Existing systems may use unrepresentative indicators, failing to access the entire financial lives of consumers. While some reports may emphasize the need to incorporate consumer assets, systems incorporating net worth may encounter computational issues. For example, when net worth is zero or falls below zero, computational errors may occur. Similarly, when calculating ratios such as debt-to-income and/or when a consumer has no income due to job loss, the system may produce an error and/or disregard such consumers completely. Furthermore, standard net worth estimations may not be accurately adaptable to a global environment. For instance, such estimations may rely on absolute values that may not account for varying macro-economic conditions, such as inflation rates and/or purchasing power of that country. This may prevent a standardized comparison of financial health across different countries.

Past attempts to include multiple financial health indicators may have incorporated credit scores. However, the use of credit scores may automatically misclassify, misrepresent, and/or exclude certain populations, such as “credit invisibles” who may comprise, for example, approximately 15% of consumers in the United States and/or 10% in the United Kingdom, who may lack traditional credit histories. Thus, reliance on credit scores may leave billions of the global population misclassified because only few countries may have formal credit scoring systems.

Existing systems may use equal weighting mechanisms, assuming all indicators have equal intensity of impact. However, indicators such as income may not carry the same weight as life insurance in different circumstances. Alternative weighting systems may use “relativity” based on the subjective assessment of a developer. Even when weights may be generated based on specific data sets, they may suffer from “fixed effects,” where the advent of new data may dictate re-estimating the whole process, which can be costly and/or complex.

Existing data-based tools may also rely on ineffective categorization of debt, such as classifying mortgage debt as “good” and credit card as “bad.” This may misguide consumers because such categorization may not allow for personal circumstances. For example, a “bad” debt may have been used to circumnavigate financial ruin, and a “good” debt may become unsustainable. Furthermore, existing tools may operate on assumptions that may view consumption solely as detrimental to wealth building, which may encourage consumers to spend minimal amounts, which may negatively impact their standard of living.

While global campaigns may have tried to increase the number of individuals possessing bank accounts, this may not necessarily equate to adequate financial health. Thus, systems capable of measuring and/or identifying the policy impacts of financial inclusion initiatives across the world may be lacking.

Finally, existing tools may present lags in reporting time, which can delay effective policy action. For instance, major global survey-based tools may operate on infrequent cycles, such as being conducted every three years. Consequently, the data provided to stakeholders may be historical. During period of rapid macro-economic shifts, such as changes in inflation rates, interest rates, and/or global financial crises, data collected on such intermittent schedules may fail to capture the immediate impact on consumer standard of living and/or financial stability. As a result, policy makers and/or governments may be forced to rely on outdated metrics that may not reflect the current realities of household finances, which may make timely and/or targeted economic interventions difficult.

In light of the foregoing, improvements to these and other drawbacks of existing systems and/or methods are therefore desirable.

### BRIEF DESCRIPTION OF THE DRAWINGS

The accompanying drawings, which are incorporated in and constitute a part of this specification, illustrate several embodiments directed to one of ordinary skill in the art and, together with the description, serve to explain the disclosed principles. It should be noted that, in accordance with standard practice in the industry, various features are not drawn to scale. In fact, the dimensions of the various features may be increased or reduced for clarity of discussion. In the drawings:

FIG. 1 is a block diagram of an exemplary computer system for implementing the process of the present disclosure.

FIG. 2 is a network diagram illustrating a system environment for implementing one or more embodiments of the present disclosure.

FIG. 3 is a flowchart illustrating the general system process for generating a financial health index, according to at least one embodiment of the present disclosure.

FIG. 4 is a flowchart illustrating a method for creating an index account, generating at least one personal financial health index using at least one variable, and/or providing access to the index, according to at least one embodiment of the present disclosure.

FIG. 5 is a flowchart of an input building used to collate input sources for a set of category inputs to initiate the generation of a personal financial health index, according to at least one embodiment of the present disclosure.

FIG. 6 is a flowchart illustrating a process for determining at least one isolated input, specifically regarding retirement savings, for advanced modeling which may create factor components which may be used to generate the financial health index, according to at least one embodiment of the present disclosure.

FIG. 7 is a flowchart illustrating a process for determining at least one isolated input, specifically regarding a credit access score, for advance modeling which may create factor components used to generate the financial health index, according to at least one embodiment of the present disclosure.

FIG. 8 is a diagram showing classifications of an internally generated credit access score, according to at least one embodiment of the present disclosure.

FIG. 9 is a flowchart illustrating a method for estimating a behavior rating for the internally generated credit access score, according to at least one embodiment of the present disclosure.

FIG. 10 is a flowchart illustrating interactions and/or interrelationships between variables used to determine financial health, according to at least one embodiment of the present disclosure.

FIG. 11 is a flowchart illustrating the provision of comparative statistics for users to analyze and/or compare results with other data pools, according to at least one embodiment of the present disclosure.

FIG. 12 is a schematic diagram of a display interface showing summary information on current and/or historic financial health indexes and/or sub-indexes, according to at least one embodiment of the present disclosure.

FIG. 13 is a diagram showing a sample report generated by the personal financial health index system as displayed on a client device such as desktop computers and/or lap-top computers, according to at least one embodiment of the present disclosure.

FIG. 14 is a diagram showing a sample report generated by the personal financial health index system as displayed on a client device such as smartphones, according to at least one embodiment of the present disclosure.

FIG. 15 is a diagram illustrating a sample report generated by the personal financial health index system regarding country variables and/or index results, according to at least one embodiment of the present disclosure.

FIG. 16 is a flowchart illustrating a process for providing access to a personal financial health index and/or report for users requesting information for a single subject, according to at least one embodiment of the present disclosure.

FIG. 17 is a flowchart illustrating a process for providing access to a personal financial health index and/or report for users request information for a plurality of subjects, according to at least one embodiment of the present disclosure.

FIG. 18 is a flowchart showing how an individual user may access, generate, and/or view a personal financial health index and/or reports, according to at least one embodiment of the present disclosure.

FIG. 19 is a flowchart showing how an employer may access, generate, and/or view a personal financial health index and/or reports, according to at least one embodiment of the present disclosure.

FIG. 20 is a flowchart showing how a financial service provider may access, generate, and/or view a personal financial health index and/or reports, according to at least one embodiment of the present disclosure.

FIG. 21 is a flowchart showing how a researcher may access, generate, and/or view a personal financial health index and/or reports, according to at least one embodiment of the present disclosure.

Like reference numerals refer to like parts throughout the several views of the drawings. Reference numbers that are repeated across plural figures are intended to identify the same features in various implementations. Other features of the present embodiments will be apparent from the accompanying drawings and from the detailed description that follows.

### DETAILED DESCRIPTION

All illustrations of the drawings are for the purpose of describing selected versions of the present invention and are not intended to limit the scope of the present invention.

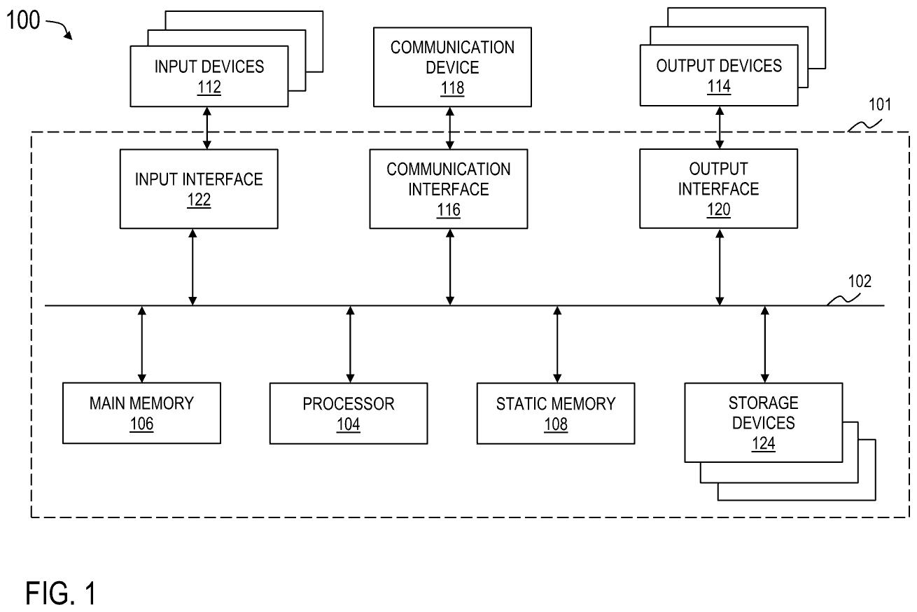

Referring to FIG. 1, a block diagram illustrating an exemplary computer system upon which the process of the present disclosure may be implemented is shown. The computer environment 100 may comprise any combination of computing devices 101, such as personal computers, mobile phones, smart televisions, handheld devices, and/or servers. The computer system may include a bus 102, at least one processor 104, a main memory 106 such as a random access memory (RAM), a read-only memory (ROM), a static memory 108, at least one storage device 124, at least one input device 112, an input interface 122, at least one output device 114, an output interface 120, a communication device 118, and/or a communication interface 116. The bus 102 may operate to allow communication and/or data transfer between the various components of the system. The at least one processor 104 may be general-purpose digital processors configured to interpret and/or execute process instructions which may be stored in the main memory 106, static memory 108, and/or the ROM. The storage device 124 may include a magnetic, op-tical, and/or solid-state recording medium, such as a hard disk drive, flash memory, and/ or compact discs. The at least one input device 112 may include at least one mechanism such as a keyboard, keypad, mouse, and/or voice recognition interface to allow data input. The at least one output device 114 may include, for example, a display and/or a printer. The communication interface 116 may comprise mechanisms that may allow the computer system to communicate with other devices over a network.

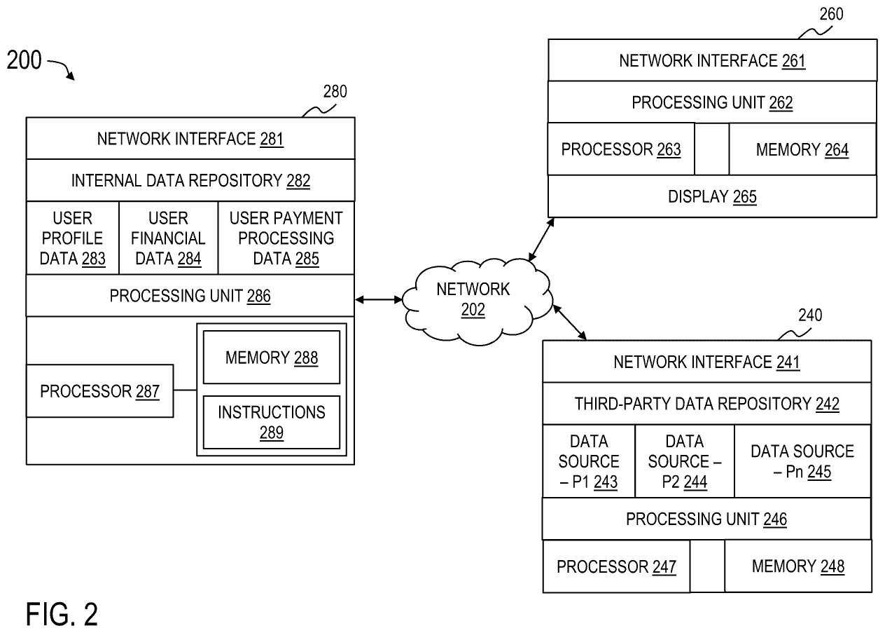

Referring to FIG. 2, a network environment is illustrated in which at least one embodiment of the present disclosure may be implemented. The system may operate over a network 202, which may act as a communication medium to interconnect a plurality of computing entities or devices, such as a data extraction server 240, a user input and display server 260, and/or a data processing server 280. These entities may be communicatively coupled via respective network interfaces 241, 261, 281 using various communication configurations, such as a Local Area Network (LAN), a wireless network (WLAN), the Internet, and/or other transmission protocols. As shown in the illustrated embodiment, the user input and display server 260 may function as the client-side interface. The server 260 may include a processing unit 262 comprising a processor 263 and a memory 264, and/or a device display 265. The system may further comprise the data processing server 280 configured to act as the computational engine. This server 280 may manage an internal data repository 282 for storing regrouped information, such as User Profile Data 283, User Financial Data 284, and/or User Payment Processing Data 285. A processing unit, such as a processor 287 or Arithmetic Logic Unit, within this server 280 may execute instructions 289 which may be contained in a memory 288 to interpret the user's financial data 284 and/or generate diagnostic indexes. Program instructions 289 may be input into memory 288 from another computer readable medium such as a compact disk, flash drive, etc., or from another device via the network interface 281. To support these operations, the data extraction server 240 may be utilized to interface with third-party data repositories 242, such as external financial institutions, to authenticate and/or retrieve structured data. The third-party data repository 242 may include various data sources, such as Data Source P1 (e.g., a financial institutions server) 243, Data Source P2 244, and/or Data Source Pn 245.

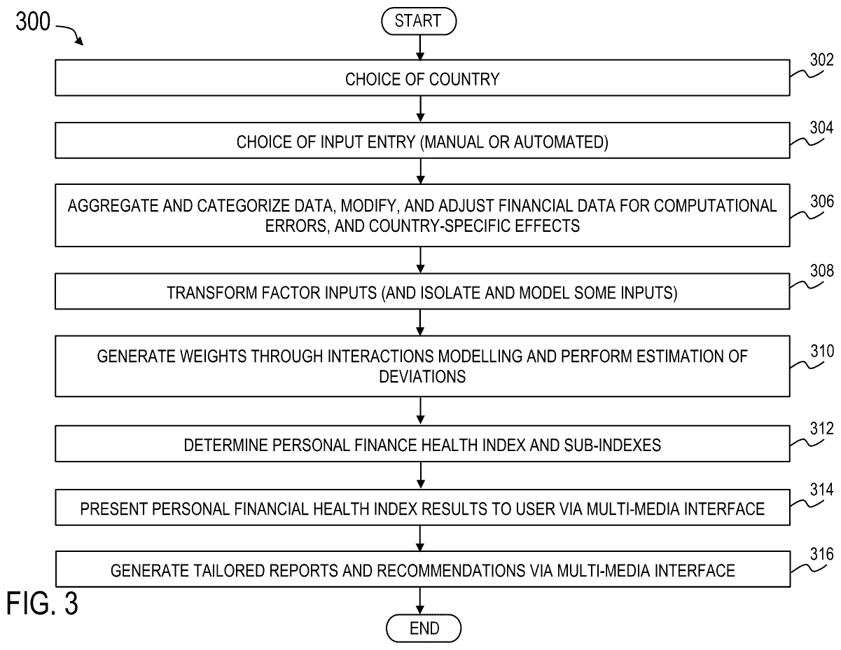

Explanation of the overall processing will be given using the flowchart of FIG. 3 for the financial health assessment process executed by the system according to the present disclosure. In step 302, the system may receive a selection of a country for assessment, which may be chosen by the user. In step 304, the system may facilitate input entry based on a selected mode. If a manual mode is selected, an input builder process may be invoked. If an automated mode is selected, a data extraction process via a financial institution may be invoked. In step 306, the system process may aggregate and/or categorize the data, and/or perform processing to adjust the categorized data for computational errors and/or country-specific effects. In step 308, the system processor may transform factor inputs and/or may initiate the isolation and/or modeling of specific inputs derived from the data adjusted for country-specific effects and/or computational errors. In step 310, the system may generate weights through processing that may include the estimation of interactions and/or benchmark deviations. In step 312, the system may determine the personal financial health index and/or sub-indexes based on the generated weights. In step 314, the results may be presented to the user device via a multimedia interface. Finally, in step 316, the system may generate tailored reports and/or recommendations, which may be presented to the user device via the multimedia interface.

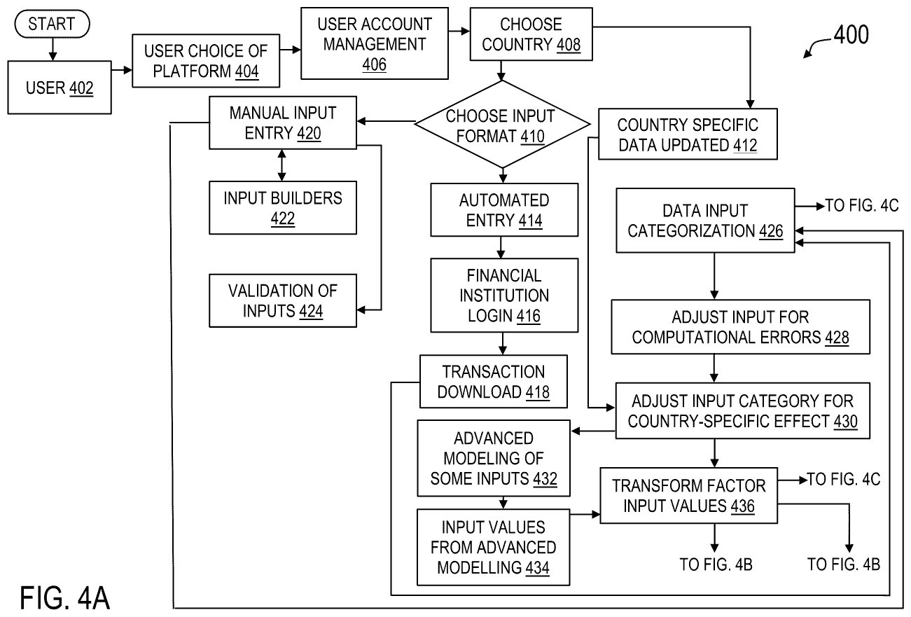

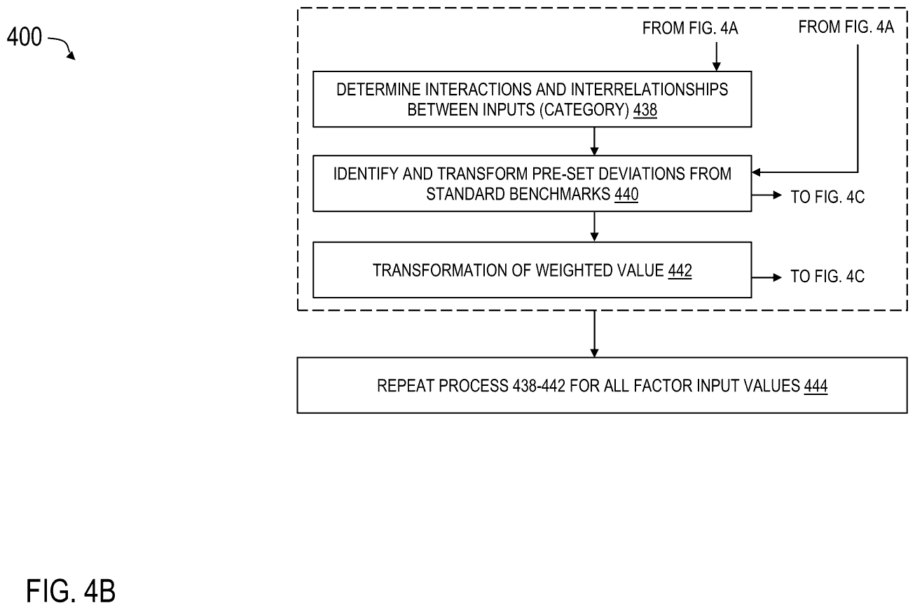

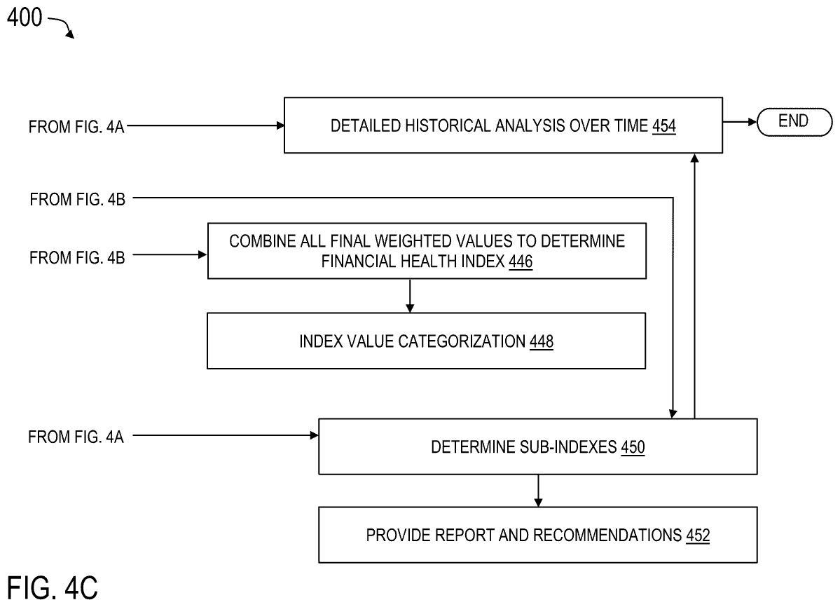

Referring to FIG. 4, the operational flow for account initialization and/or data acquisition according to at least one embodiment is illustrated. In step 404, the system may receive a user choice of platform to initiate access to the financial health diagnostic tool regarding a user 402. Following this selection, in step 406, the system may execute an account creation and/or management process. During this step, the system may acquire personal credentials from the user, such as a registered email address and/or a telephone number, and/or may execute a multi-factor authentication protocol by transmitting a time-limited text code to the user. To provide data security, step 406 may further include processing for establishing specific access specifications, such as fingerprint verification, password entry, and/or facial recognition. Additionally, the system may configure an auto-termination protocol which may log off the account if the system detects that the program may have been left unattended for a pre-set period.

In step 408, the system may determine the local country context for the assessment. This step may be performed by receiving a manual selection from the user. Alternatively, step 408 may involve the system processor activating a Global Positioning System (GPS) via the network interface to automatically detect the physical location of the user device and/or populate the corresponding country data. The system may also verify this location by generating a unique access code and/or cross-referencing a residential address provided during step 406.

In step 412, based on the country determined in step 408, the system process may execute processing to automatically update a repository of country-specific data. This processing may involve retrieving current macro-economic variables, such as inflation rates, interest rates, unemployment rates, life expectancy, state pension ages, and/or Gross Domestic Product (GDP), from external statistical agencies via Hypertext Markup Language (HTML) protocols and/or Uniform Resource Locators (URLs). Also in step 412, the system may create a temporary data repository pre-populated with country data and/or financial boundaries. This temporary web archive may allow the user device to parse data through the processing unit even in the absence of an active network transmission so that the assessment may remain functional in offline environments.

With continued reference to FIG. 4, in step 410, the system may prompt the user to select a source for feeding financial information into the program. If an automated entry mode is selected in step 414, the system may activate an Application Programming Interface (API) configured to integrate with the servers of a third-party financial institutions. In step 416, the API may initiate authentication using the user's credentials over a secure protocol, for example, File Transfer Protocol (FTP) and/or Secure Hypertext Transfer Protocol (HTTPS), to help identify the Uniform Resource Locator (URL) of the financial institution's server. Upon verification, in step 418, the system may extract structured financial data, such as transaction histories and/or account balances, and/or store this data in the internal data repository. A redundancy buffer may be implemented in this process to notify the user via text and/or email if extraction fails, prompting for a pre-set alternative.

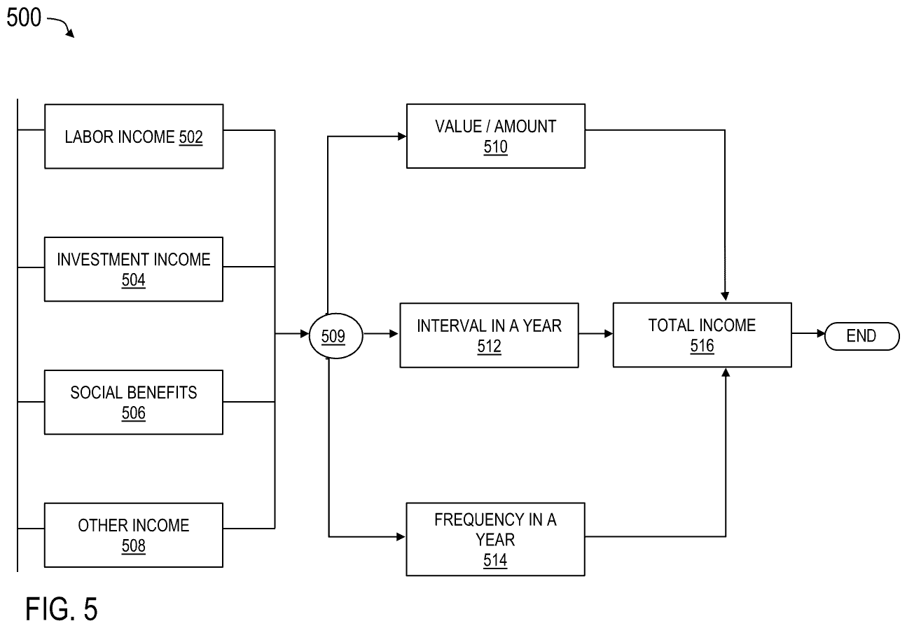

If a manual entry mode is selected in step 420, the system may invoke an input building process, which is further illustrated in FIG. 5. In the input building process, the system may define specific input sources, such as labor income 502, investment income 504, social benefits 506, and/or other income 508. At step 509, the values may be transformed. For each source, the system may receive parameters including the value amount 510, the interval of the input 512 (for example, weekly and/or monthly), and/or the frequency in a year 514. In step 516, the system processor may transform these parameters to provide a total annualized value 516 for the category. Additionally, the system processor may be configured to transform a volatility indicator, for example from a scale from 0 to 1, based on the identified gaps and/or irregularities in the income pattern, which may serve as a measure of financial risk.

Returning to FIG. 4, in step 424, the system may validate the inputs acquired from the automated and/or manual modes. The system processor may cross-reference input values against public records, for example tax records and/or voter registries, and/or employment details extracted from the financial institution server. Based on this verification, the system may generate an accuracy scale, such as a percentage score and/or a color-coded indicator such as green for verified and red for incomplete, to reflect the reliability of the data.

In step 426, the system processor 287 may execute instructions 289 to identify and/or group the verified financial data stored in the internal data repository 282 into specific input categories. These categories may be designated as X₁, X₂, X₃ . . . Xₙ, wherein X₁ may represent Income (from all sources), X₂ may represent Spending (discretionary and/ or non-discretionary), X₃ may represent Debt Repayment (secured and/or unsecured), X₄ may represent Assets (cash and/or non-cash), X₅ may represent Liabilities, X6 may represent Insurance, and/or Xₙ may represent a Credit Score (either self-reported, externally generated, and/or internally generated), according to some embodiments. During this processing, the system processor 287 may be configured to analyze transaction outflows against inflows to distinguish between routine spending and/or asset acquisition.

In step 428, the system may perform processing to adjust the categorized inputs for computational errors, particularly to address scenarios involving null denominators. In calculating factor inputs, the system may utilize ratios Z=X/Y, where X is a numerator representing debt and Y is a denominator representing income, for example. If the denominator is Y is zero, for example, in the case of a user who has lost their employment, standard computation may result in a system error and/or the exclusion of the user from the assessment. To resolve this, the system processor 287 may be taught to apply an adjusting mechanism that may transform the ratio variables rather than discarding the user and/or using a fixed integer adjustment (such as adding 1) which may distort the intensity of the financial burden.

Specifically, the Zero Denominator Adjustment transformation performed by the system and/or method concerning the above described calculation X/Y where Y is zero can be described by the following relations:

X/Y->(X(n)+r)/(Y(n)+r)

wherein n represents a non-zero whole number and r represent a rate of adjustment in currency units. Following this transformation, the system processor may perform a transformation to generate a probabilistic scale using the following relations:

Zₙ=Pₙ(0-1, 1-2, 2-4 . . . Pₙᵢ)

where Zₙ represent the transformation ratio from the previous transformation. This probabilistic extension may allow the system to indicate the degree of intensity for the financial indicator, for example, distinguishing between a debt load of 100 versus 10,000 for users with zero income. Thus, this transformation may provide that the system more accurately assess unemployed users and/or users with no income without causing computational failure.

In step 430, the system processor 287 may be configured to adjust the modified inputs based on the country-specific data 112 to reflect the acute socio-economic environment of the chosen country. The system may quantify how the local cost of living, such as rising inflation, affects the user's ability to utilize their economic resources to maintain a sustainable standard of living. The transformation performed by the system and/or method to calculate the effective available resources can be described by the following relations:

Si=Es−Cs

wherein Si represents the Available Resources, Es represents the Economic Resources such as earned income and/or assets, and Cs represents the Calculated Factors that may affect the cost of living. By applying this relation, the system may accurately distinguish between users with identical nominal incomes who reside in countries with vastly different purchasing power and/or inflation rates.

Following the adjustment for country-specific effects in step 430, the system processor 287 may be configured to execute an advanced modeling process 432. In this step, the system may identify and/or isolate specific category inputs 426 that may possess multifaceted characteristics influenced by a plurality of external variables. While some financial inputs may be utilized directly, such as spending, others, specifically Retirement Savings and/or Credit Access Scores, may require complex modeling to maintain their original attribute of impact on personal financial health.

The isolation process 432 may allow the system to adjust these specific inputs against demographic variables such as age, macro-economic variables such as inflation, and/or lifestyle choices before they are used in the core calculation. A primary advantage of this isolation and/or separate modeling may be to avoid the computational pitfalls associated with using “Net Worth” as a direct indicator. As described in the present disclosure, relying on Net Worth can lead to zero-value errors and/or misleading assessments where a user with high assets but low liquidity may be incorrectly deemed financially healthy. By modeling assets and/or liabilities in isolation, for example, within the context of retirement planning and/or credit access, the system may capture the granular leverage and/or utility of those assets.

Once the advanced modeling is complete, the system may generate modified input values in step 434. These modeled values may be then reintegrate into the main algorithmic flow in step 436 to serve as the basis for transforming Factor Inputs, so that the financial index may reflect raw financial data and the complex socio-economic context of the user.

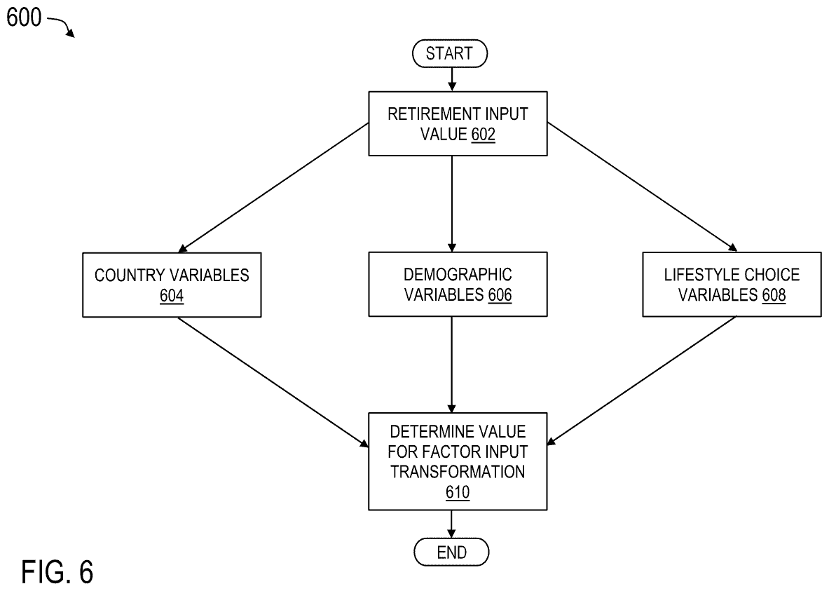

Referring to FIG. 6, the retirement savings modeling process 600 is illustrated. This process may be executed by the system processor 287 as part of the advanced modeling step 432 shown in FIG. 4 to isolate and/or adjust specific inputs before they may be utilized in the core index calculation. In this process, the system processor 287 may be configured to receive a raw retirement input value 602, such as current savings and/or pension value, provided by the user 402.

To provide the value accurately reflects the user's future financial health, the system processor 287 may transform the raw value 602 using a plurality of external and/or internal variables. These may include Country Variables 604, such as inflation rates, unemployment rates, and/or life expectancy; Demographic Variables 606, such as the user's current age and/or projected state retirement age; and/or Lifestyle Choices 608, such as estimated costs for post-retirement holidays and/or specific purchases. For instance, improvements in life expectancy within a specific country 604 may be processed to project a longer retirement duration. As a result, this may reduce the purchasing power of the current savings value 602.

In step 610, the system processor 287 utilizes executable instructions 289 to transform a modeled retirement value by applying the acquired variables to the raw input. The transformation performed by the system and/or method can be described by the following relations:

ModeledValue=((S/(I/U)−(L/Yᵣ))·(1−(A_{c}/Aᵣ))

wherein S represents the raw retirement savings value 602, I and U represent country economic variables (such as inflation and/or unemployment factors) 604, L represents the total value of lifestyle choices 608, Yᵣ represents the number of retirement years planned, A_{c} represents the user's current age, and Aᵣ represents the retirement age 606.

For illustrative purposes, if a user provides a savings value of 10,000, and the system applies an inflation factor of 1.05, an unemployment factor of 1.02, a lifestyle cost of 100,000 over 20 years, with a current age of 35 and a retirement age of 65, the processor 287 would transform the modeled value 610 as:
((10,000/(1.05/1.02))−(100,000/20))·(1−(35/65))=2,175.82 (rounded to the nearest currency unit)

The resulting modeled retirement value 610 may then be fed back into the main process at step 436 of FIG. 4 for the calculation of Factor Inputs. This modeling may allow the system to capture the granular leverage of assets relative to the user's specific life cycle and/or location.

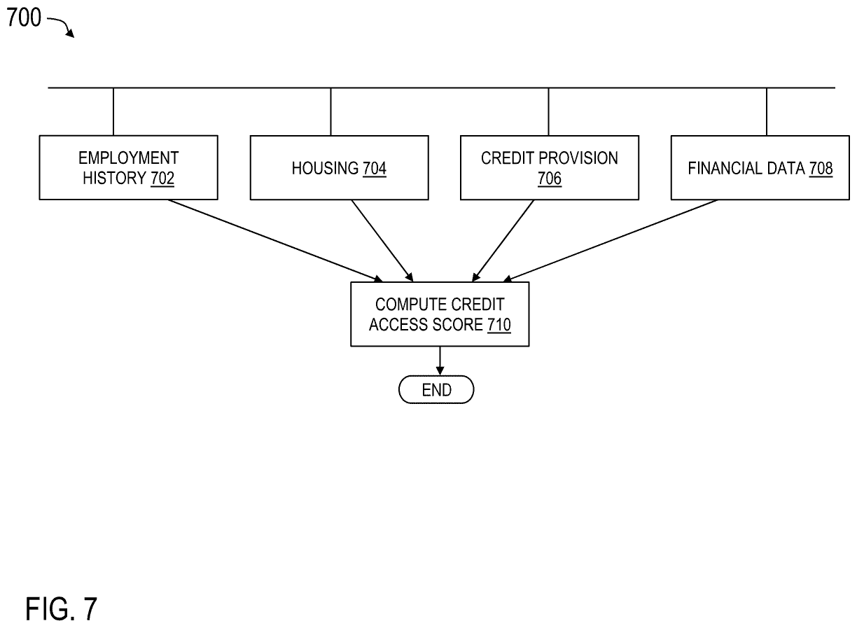

Referring to FIG. 7, the system may generate an internal credit access score 700 as part of the advanced modeling process 432. The rationale for generating a proprietary score, instead of relying on external bureaus, may be to address the issue of “credit invisibles”, who may be excluded from traditional credit scoring systems. By generating an internal score 700, the system may provide a standardized metric that may be globally applicable and/or capable of assessing financial health regardless of a user's formal credit history.

The system processor 287 may be configured to assign a credit access score 700 by analyzing components such as: Employment History 702 such as self-employment and/or employee status; Housing Details 704 such as ownership type and/or rental history; Credit Provision 706 such as the ability to sustainably handle credit obligations; and/or Financial Data 708 which may be derived from the verified category inputs 426. The system processor 287 may be taught to transform these components with the country-specific adjustments 430 so that the score reflects the user's actual economic environment.

In step 710, the system may apply a specific weighting logic to the components to derive the final score. For instance, in accordance with credit affordability principles, the system may assign the highest proportionate distribution to Financial Data 708. The transformation performed by the system and/or method to calculate the score can be described by the following relations:

CreditAccessScore=(E·10%)+(C·30%)+(H·10%)+(F·50%)

wherein E represents Employment History, C represents Credit Provision, H represents Housing, and F represents Financial Data. For example, if a user meets the benchmarks for all categories (scoring 100 points in each), the processor computes:
(100·0.10)+(100·0.30)+(100·0.10)+(100·0.50)=100.

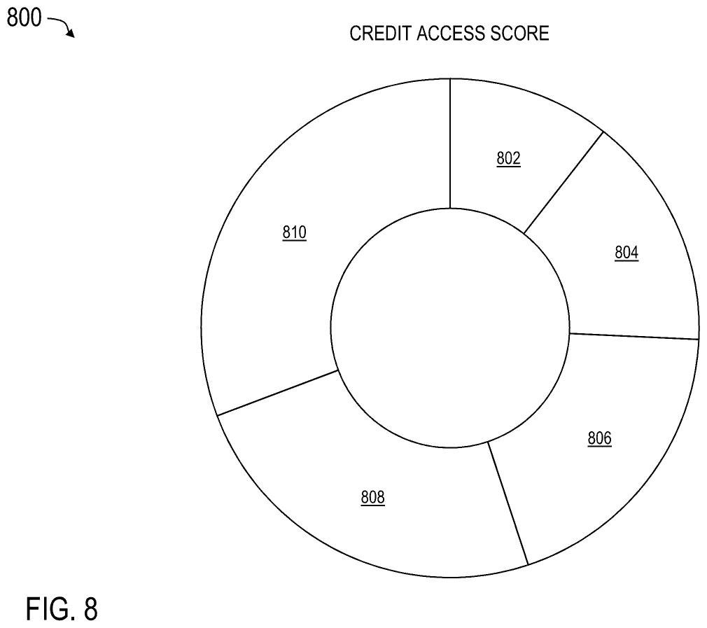

Referring to FIG. 8, the calculated credit access score may be then mapped against specific classification ranges to indicate the level of risk. The system processor 287 may classify the score into categories comprising: Very Poor (0-108) 802, Poor (109-155) 804, Fair (156-196) 806, Good (197-249) 808, and Very Good (250-314) 810. Once generated, this score may be fed back into the main processing loop 436 as a specific factor input and/or may also be made accessible to third-party financial service providers upon user authorization.

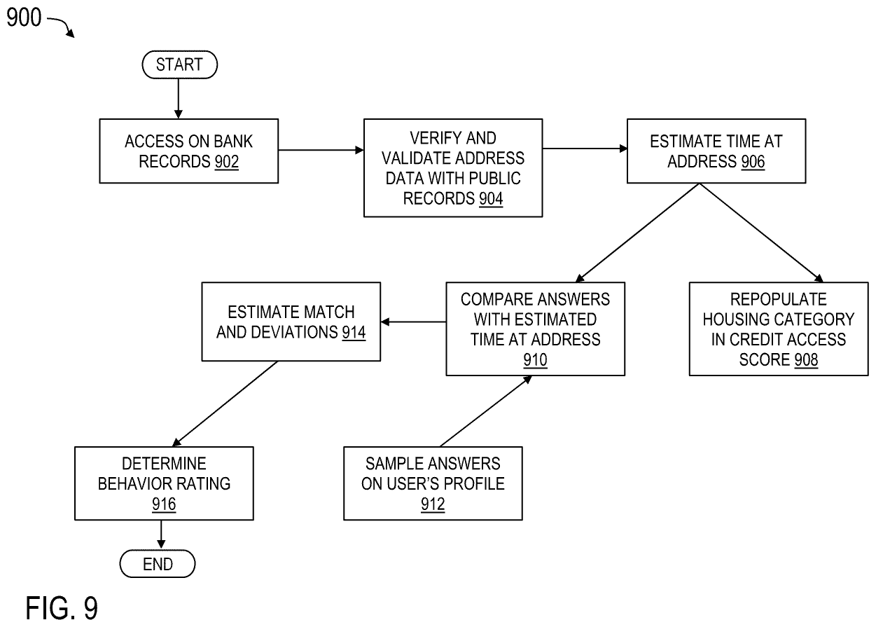

Referring to FIG. 9, the system processor 287 may be further configured via executable instructions 289 to generate a behavior rating to provide additional validation for the internally generated credit access score 710. In step 912, the system may prompt the user 102 to answer a series of pre-defined questions based on the input categories. For example, the system may query the user regarding the duration of their residence at a current address and the duration of their employment at the current place of employment. Concurrently or prior to this step, the system processor 287 may execute a background estimation process to determine a verified value. In step 902, the system may extract address data from the user's financial institutional records 242 such as bank statements and, in step 904, verify this data against public records such as a voter registry to confirm validity. Based on these records, in step 906, the system processor 287 may calculate an estimated time at the address.

In step 910, the system process 287 may compare the user's response from step 912 against the estimated data derived in step 906. Proceeding to step 914, the system may estimate the match and/or quantify any deviation between the stated value and/or the verified value. The system processor 287 may be taught to utilize a deviation logic wherein if the user's answer is T and the verified information is P, the deviation M may be calculated as T-P. For example, if the system may identify that the user has lived at an address for four years based on independent records, but the user asserts six years, the system may calculate a deviation of two.

In step 916, the system may determine a behavior rating based on the quantified deviation. The system process 287 may map the derivation to a pre-defined reliability scale, for example, a scale ranging from A to E. In this configuration, a rating of A (zero deviation) may indicate a “Highly Credible” user, while a rating of E may indicate an “Unreliable” user. While this behavior rating may not be utilized in the mathematical calculation of the personal financial health index 446, it may serve as a critical metadata indicator for third-party entities, such as financial service providers. This may allow institutions to adjust their internal risk mechanisms by understanding the behavioral credibility of the applicant alongside their numerical financial health.

In step 436 (and/or step 308 of FIG. 3), the system processor 287 may initiate the transformation of factor inputs using the adjusted financial data 430 and/or the modeled isolated inputs 434 stored in the internal data repository 282. The system may be configured to transform a plurality of base ratios, designed as Factor Inputs, which may serve as the foundational metrics for financial health assessment. These factor inputs may include, without limitation, a Savings Indicator, a Solvency Indicator, a Protection Indicator, a Future Indicator, and/or a Liquidity Indicator.

The system processor 287 may transform the Savings Indicator to determine if the user may be living within their means. Utilizing the adjusted category inputs for income (I) and Spending(S), the transformation performed by the system and/or method can be described by the following relations:

Saving Indicator=1−(S/I)

For example, if the user's spending is 8,000 and income is 10,000, the system calculates a ratio of 0.80, resulting in a Savings Indicator of 1−0.80=0.20.

The system processor 287 may transform the Solvency Indicator to assess the user's ability to service short-term debt obligations. Unlike existing models that may categorize debt subjectively as “good” or “bad,” the system may focus on the debt burden relative to income. Using the adjusted Debt Repayment input (D), the transformation performed by the system and/or method can be described by the following relations:

Solvency Indicator=D/I

For example, if the debt repayment is 3,000 and income is 10,000, the Solvency Indicator is transformed as 0.30.

The system processor 287 may transform the Protection Indicator to identify if the user has made adequate provision for dependents and/or liabilities. Using the adjusted Insurance input (Ins) (for example, life insurance value), the transformation performed by the system and/or method can be described by the following relations:

Protection Indictor=Ins/I

For example, in the insurance value is 120,000 and income is 10,000, the Protection Indicator is transformed as 12.

For the Future Indicator, the system may utilize the isolated retirement value 610 derived from the advanced modeling process 432. The system may match this modeled value (Rv) against the user's Total Assets (A) to identify if the user may be adequately prepared for future consumption spending. The transformation performed by the system and/or method can be described by the following relations:

Future Indicator=Rv/A

For instance, using a modeled retirement value of 13,000 and total assets of 25,000, the Future Indicator may be transformed as 0.52.

The system processor 287 may transform the Liquidity Indicator to determine if the user can support spending during income shortfalls. This transformation may utilize the savings value (Sv) derived from the modeling process and/or match it against Spending(S). The transformation performed by the system and/or method can be described by the following relations:

Liquidity Indicator=Sv/S

For example, if the available savings value is 2,000 and spending is 8,000, the Liquidity Indicator is transformed as 0.25. By utilizing these adjusted and/or modeled inputs, the factor inputs may reflect the user's effective financial reality.

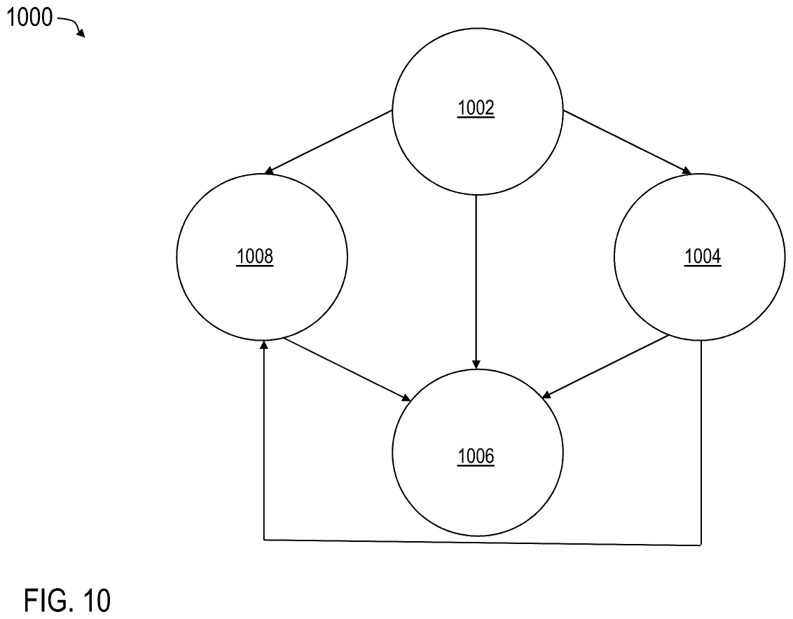

Referring to FIG. 10 and step 438 of FIG. 4, the system processor 287 may be configured to execute an interaction modeling process 1000. Unlike existing models that may treat financial indicators in isolation, the system processor 287 may utilize executable instructions 289 to quantify the complex interrelationships between category inputs (X₁ 1002, X₂ 1004, X₃ 1006, X₄ 1008). This modeling may be performed using mathematical equations, sequences, series, and/or neural networks to determine how the value of one input may be influenced by the characteristics of another.

To capture these nuances, the system processor 287 may be taught to split a single financial indicator into constituent components to determine a relationship value. For example, if a user has a “Savings Rate” of 30, the system may decompose this into Retirement Savings (20), Emergency Savings (2), and/or Investments (8), for example. The processor then may execute a transformation protocol to derive an interaction value, for example:

Relationship Value=1·0.7·0.2·0.02·0.08=0.000224

wherein the multipliers represent weighted factors of income, spending, and the specific savings split. Conversely, for a second user with the same total savings rate (30) but a different allocation, for example, Retirement (28), Emergency (1), Investments (1), the system may compute the following transformation:

Relationship Value=1·0.7·0.28·0.01·0.01=0.0000196

This interaction modeling 438 may allow the system to distinguish between the financial health quality of different portfolio compositions that might otherwise appear identical on the surface.

In step 440, the system processor 287 may initiate a deviation analysis to compare the transformed Factor Inputs 436 against standard industry benchmarks. The system may establish a standard benchmark, for example, 36% for debt-to-income, and/or define a pre-set deviation range, for example, ±10%, creating a limit of 10% to 30% if the base is 20%. The system processor 287 may be configured to calculate a Deviation Value (Dv based on whether the user's factor input may fall within, above, or below these benchmarks limits.

If the factor input falls within the benchmark range, such as a Solvency Indicator of 30%, the transformation performed by the system and/or method can be described by the following relations:

Dv=(X/Bmax)·(Bmax−Bmin)

where X represents the Factor Input Value.

For example, (30/30)·(30−10)=20. If the factor input falls above the benchmark range, for example 40%, indicating potential financial stress, the transformation performed by the system and/or method can be described by the following relations:

Dv=(X/Bmax)·(Bmin−Bmax)

For example, (40/30)·(10−30)=−26.66. if the factor input falls below the benchmark range, for example 5%, the transformation performed by the system and/or method can be described by the following relations:

Dv=((Bmax/X)·(Bmax−Bmin))+(1−(Bmin/(Bmax−Bmin)))

Through these transformations, the system processor 287 may evaluate the intensity of the financial indicator relative to established standards, generating a granular metric that may reward sustainable financial behaviors and/or penalize risk proportionality.

In step 442 (and/or step 310 of FIG. 3), the system processor 287 may initiate a dynamic weight generation process via executable instructions 289. In contrast to existing financial health models that may rely on fixed and/or subjective weighting, the present disclosure may generate personalized weights by multiplying the transformed Factor Input 436 by the Interaction Value 438 and/or the Deviation Value 440 derived from the previous steps.

The system processor 287 may be configured to execute a sequence of equations to generate specific weights for each financial indicator. Utilizing the exemplary values derived in previous steps (where the Interaction Value is 0.000224 and the Deviation Value is 20), the processor may transform the weights as follows: For the Savings Indicator, the transformation performed by the system and/or method can be described by the following relations:

Weight_{Savings}=0.20 (Factor)·0.000224 (Interaction)·20 (Deviation)=0.000896

For the Solvency Indicator, the transformation performed by the system and/or method can be described by the following relations:

Weight_{Solvency}=0.30·0.000224·20=0.001344

For the Protection Indicator, the transformation performed by the system and/or method can be described by the following relations:

Weight_{Protection}=12·0.000224·20=0.05376

For the Future Indicator, the transformation performed by the system and/or method can be described by the following relations:

Weight_{Future}=0.52·0.000224·20=0.0023296

For the Liquidity Indicator, the transformation performed by the system and/or method can be described by the following relations:

Weight_{Liquidity}=0.25·0.000224·20=0.00112

For the Access to Credit Indicator, the transformation performed by the system and/or method can be described by the following relations:

Weight_{Credit}=0.79·0.000224·20=0.003539

These exemplary transformed weights 442 may be stored in the system memory 288 and/or represent the user's “Actual Weights” based on the their specific financial reality.

Following this calculation, the system processor 287 may repeat the process to generate “Projected Weights” (or Ideal Weights). In this iteration, the system may replace the user's actual Factor Inputs 436 with pre-defined standard industry benchmarks, for example, using a 15% benchmark for savings or 40% for solvency limits. This process may establish a theoretical upper and lower boundary for the index. The system may execute the following transformations to store the projected weights: For the Savings Benchmark (for example, 0.15), the transformation performed by the system and/or method can be described by the following relations:

Projected Weight=0.15·0.000224·20=0.000672

For the Solvency Benchmark (for example, 40), the transformation performed by the system and/or method can be described by the following relations:

Projected Weight=0.40·0.000224·20=0.001792

For the Protection Benchmark (for example, 15), the transformation performed by the system and/or method can be described by the following relations:

Projected Weight=15·0.000224·20=0.0672

For the Future Benchmark (for example, 0.22), the transformation performed by the system and/or method can be described by the following relations:

Projected Weight=0.22·0.000224·20=0.000986

For the Liquidity Benchmark (for example, 0.50), the transformation performed by the system and/or method can be described by the following relations:

Projected Weight=0.50·0.000224·20=0.00224

For Access to Credit Benchmark (for example, 1.0), the transformation performed by the system and/or method can be described by the following relations:

Projected Weight=1.0·0.000224·20=0.00448

By generating actual and projected weights, the system may create a comparative framework that may allow the final index to reflect performance relative to an optimized financial state tailored to the user's specific environment.

Referring back to FIG. 4B, in step 444, the system processor 287 may be configured to repeat the process steps 438 through 442 for all remaining factor input values.

In step 446 (and/or step 312 of FIG. 3), the system processor 287 may utilize the executable instructions 289 to combine the weighted values generated in the previous steps to determine the final financial health metrics. This process may involve the transformation of two distinct aggregate factors: an Estimated Index Factor which may be based on the user's actual financial reality and a Projected Index Factor which may be based on ideal industry benchmarks.

First, the system processor 287 may retrieve the personalized “Actual Weights” stored in the system memory 288 and/or perform a summation operations to generate the Estimated Index Factor. Using the exemplary values derived previously, the transformation performed by the system and/or method can be described by the following relations:

Estimated Index Factor=0.000896+0.001344+0.05376+0.0023296+0.00112+0.003539=0.062989

Second, the system processor 287 may retrieve the “Projected Weights” which may have been transformed using pre-defined standard benchmarks, and/or perform a summation operation to generate the Projected Index Factor. The transformation performed by the system and/or method can be described by the following relations:

Projected Index Factor=0.000672+0.001792+0.05376+0.000986+0.00224+0.00448=0.06393

This Projected Index Factor may establish the theoretic upper or optimal boundary for the assessment, which may set a “perfect” score baseline tailored to the specific weighting logic of the system.

Finally, in step 446, the system processor 287 may derive the final Personal Financial Health Index by transforming the ratio of the Estimated Index Factor to the Projected Index Factor. This computational approach may allow the final score to reflect the user's performance relative to an optimized financial state. The transformation performed by the system and/or method can be described by the following relations:

Index=(Estimated Index Factor/Projected Index Factor)·100

For example: Index=(0.062989/0.06393)·100=98.5

The resulting value, for example 98.5, may serve as the definitive Personal Financial Health Index, which may be expressed as a single integer, a decimal, and/or mapped to a specific status classification, for example, on a scale of 0 to 100. In step 448, the system processor 287 may execute an index value categorization process. The calculated index value may be mapped to a status classification 1306 to provide qualitative context to the user. For example, a score of 65 may be categorized as “Average” based on pre-defined ranges stored in the database. In step 450, the system may determine a plurality of sub-indexes. The processing may retrieve the individual factor inputs calculated for each factor, for example, savings, solvency, protection, future, and/or liquidity, and/or together with the estimated deviations 440 transform the individual factor inputs into standalone scores (sub-indexes) using a scale of 0 to 10, for example. These sub-indexes may allow the user to view the performance of specific financial areas independently of the aggregate score, so that users may identify specific strengths and/or weaknesses independent of the aggregate score. Furthermore, the system may execute a detailed historical analysis over time 454 to track performance trends.

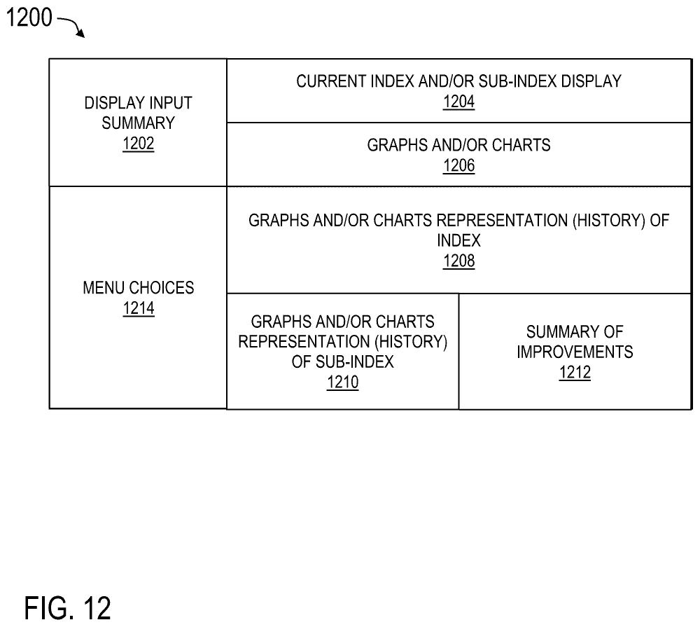

Referring now to FIG. 12, the system may be configured to present a summary display 1200 to the user 102 via the display unit 265. This dashboard layout may serve as a centralized hub for monitoring financial health. The system processor 287 may generate a current status section 1204, which simultaneously may display the current Personal Financial Health Index 446 and/or the associated Sub-Indexes 450. To provide context, the display may include historical graphical representations 1208, 1210 plotting the user's index performance over a selectable time period, such as monthly, quarterly, and/or annually. Additional sections may include a category input summary 1202, a summary of improvements 1212, and/or a menu choices 1214 for navigation.

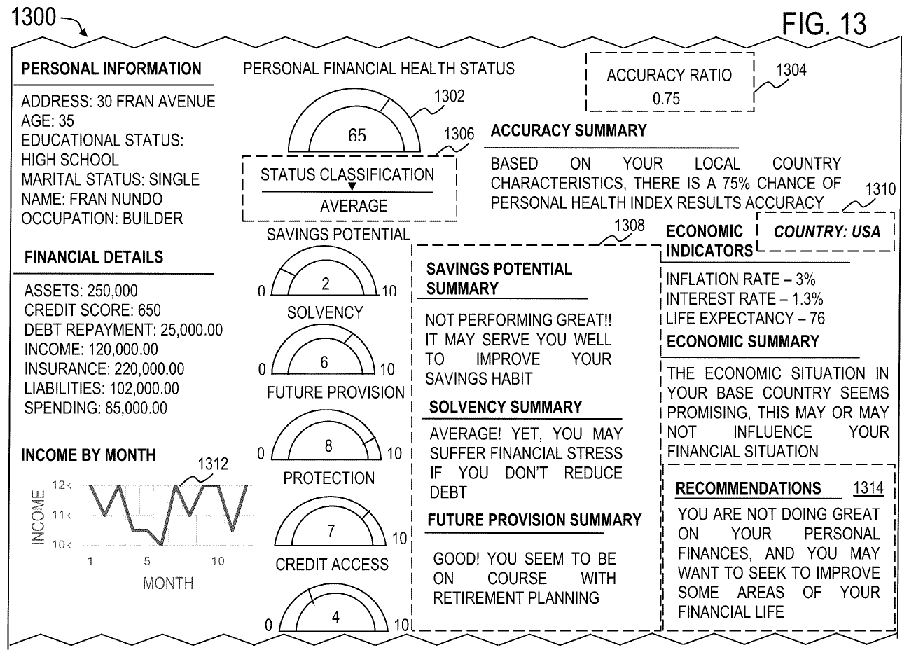

Referring to FIG. 13, the system may generate a detailed reporting interface 1300 optimized for larger screen outputs, for example on a personal computers and/or laptops. This interface may provide a comprehensive visualization of the assessment. The system may display the final index 1302 alongside a standard text classification 1306, such as “Average,” “High,” or “Very High”, to interpret the numerical result. A detailed financial indicator analysis 1312 may be presented using charts to illustrate patterns in income and/or spending. Furthermore, the system may generate specific Sub-Indexes and/or Sub-Index Summaries 1308, including Solvency Summary, Savings Potential Summary, Future Provision Summary, Liquidity Summary, and/or Credit Access Summary, which may provide deep analysis of specific stressors. The detailed financial indicator analysis 1312 may further include a visual representation of the past history of income and/or other financial data of the user.

The interface 1300 may include an Accuracy Ratio 1304. This ratio may be intended to serve to inform the user 402 regarding the fundamentals of financial well-being in their chosen country 1310. A high accuracy ratio may indicate that economic resources may be strong predictors of well-being in that location, whereas a low ratio may suggest that other factors may play a larger role. Finally, the system processor 287 may generate tailored Recommendations 1314 based on the Sub-Indexes, which may provide action-able advice. For example, a recommendation may include that the user may not be doing great on their personal finances and/or may need to seek to improve debt reduction.

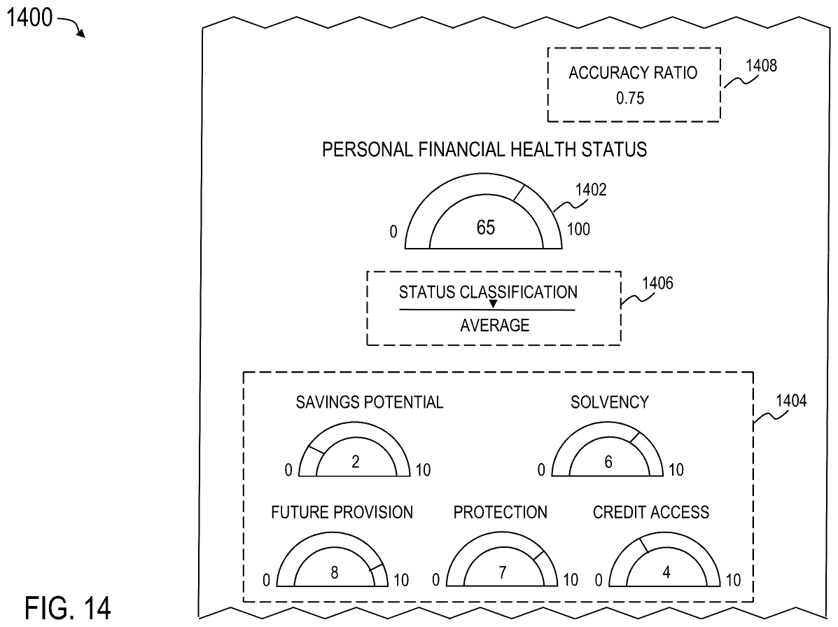

Referring to FIG. 14, the system may be further configured to generate a mobile or a small screen output 1400, for example for smartphones and/or wearable technology. This interface may include, without limitation, a fluid, simplified layout showing the Final Index 1402, the Status Classification 1406, the Sub-Indexes 1404, and/or Accuracy Ratio 1408. The system processor 287 may also be configured to transmit real-time alerts and/or periodic status messages to these devices to keep the user engaged with their financial health.

The system processor 287 may be configured to monitor the country-specific data updated in step 412 (e.g., inflation rates or interest rates). Upon detecting a change in a country-specific variable that may materially impact the user's Personal Financial Health Index 1402, the system may transmit a specific real-time alert to the device 1400. This may notify the user of external economic shifts affecting their personal financial health status

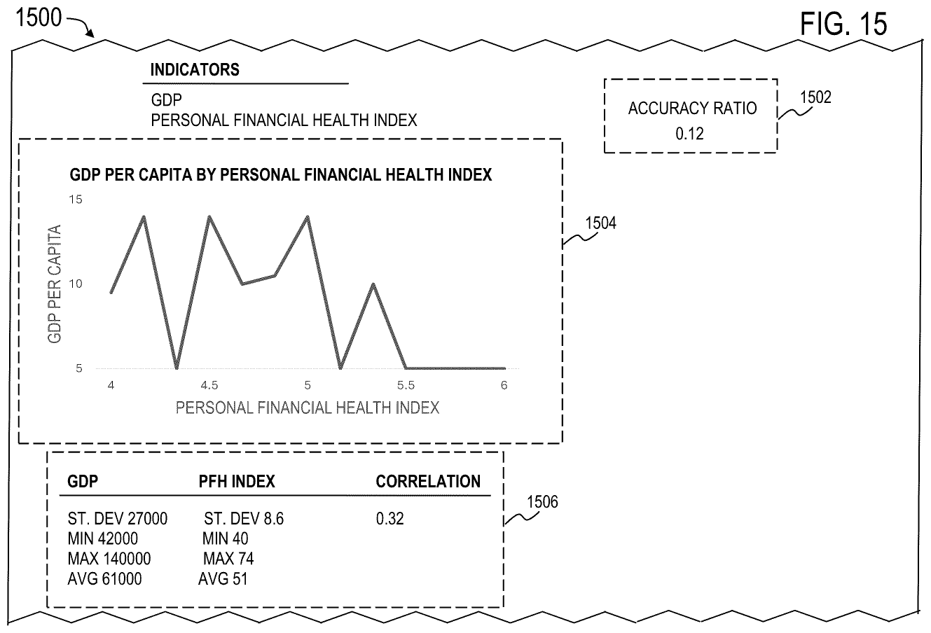

Referring to FIG. 15, the system may generate a Country Variable Analysis Report 1500. This output may correlate the user's Personal Financial Health Index 446 with macro-economic factors 1506, such as Gross Domestic Product (GDP) per capita. This analysis may illustrate the potential disconnect between national wealth and/or personal financial health. For instance, the graph 1504 may demonstrate that a high national GDP may not automatically result in high personal financial health for the user. This report may serve as a tool for users, policymakers, and/or researchers to understand the granular impact of macro-economic changes, such as inflation and/or interest rate hikes, on individual household finances.

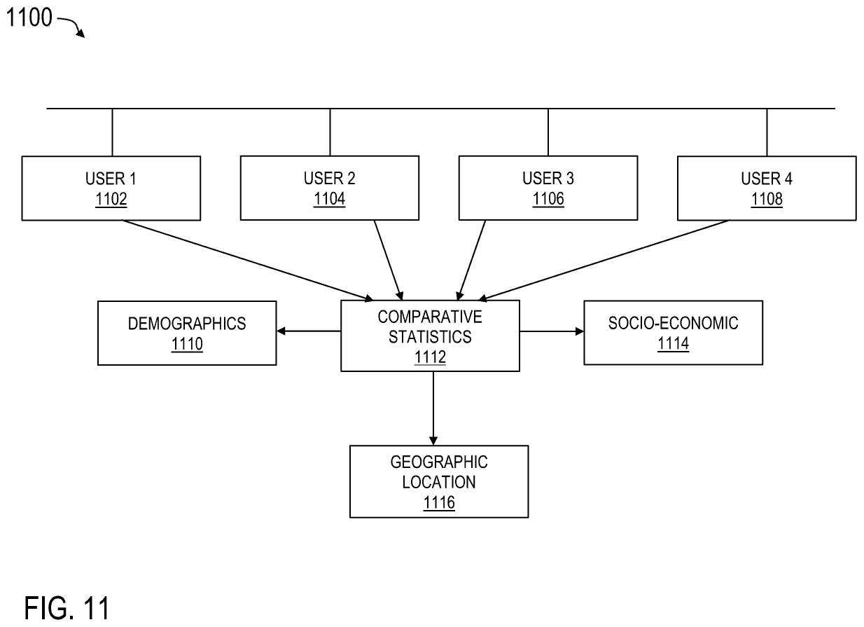

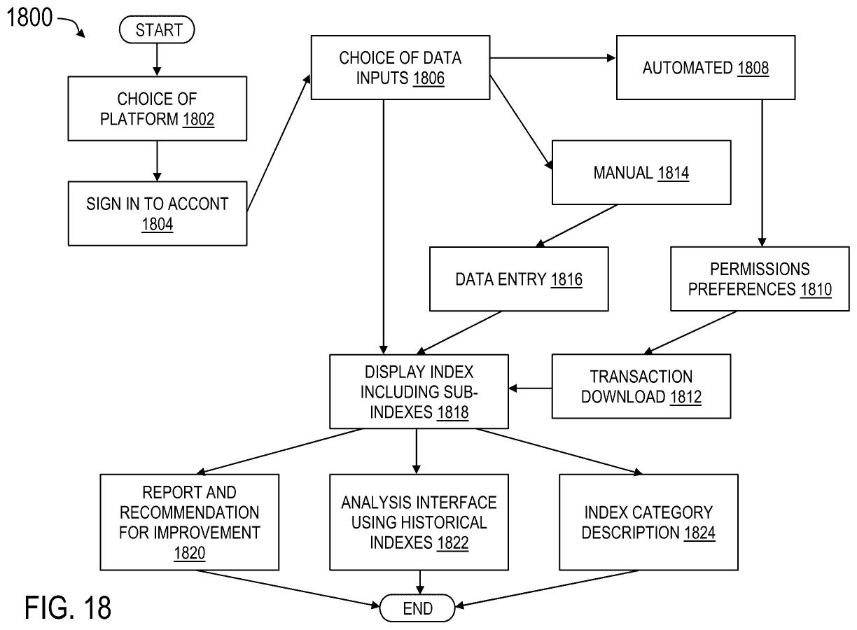

Referring to FIGS. 16 through 21 and FIG. 11, specific processing flows regarding diverse user embodiments and use cases will now be described, illustrating how the system may accommodate the varying needs and access protocols for individuals, employers, financial service providers, and/or researchers. Referring to FIG. 18, the system processes for an individual user 1800 are illustrated. In step 1804, the user may sign into the program and/or select a data input mode 1806. Depending on the selection, the system may proceed with automated transaction download 1808 or manual data entry 1814. The system processor 287 may be configured to allow users to set permission preferences 1810, determining the scope and/or timeframe of access granted to third-party providers. Upon completion, the system may display the index 1818 and/or reports and recommendations 1820. An embodiment of the system processes for an individual user may include alert configuration. In step 1822, the user may configure real-time and/or delayed alerts regarding their financial health. For example, the system processor 287 via executable instructions 289 may allow the user to schedule alerts to report only positive financial outcomes immediately and/or delay negative outcomes to ease momentary stressors. Furthermore, the user may utilize coded on-screen messages to instantly terminate third-party access to their data so that individual users can control their privacy during credit applications.

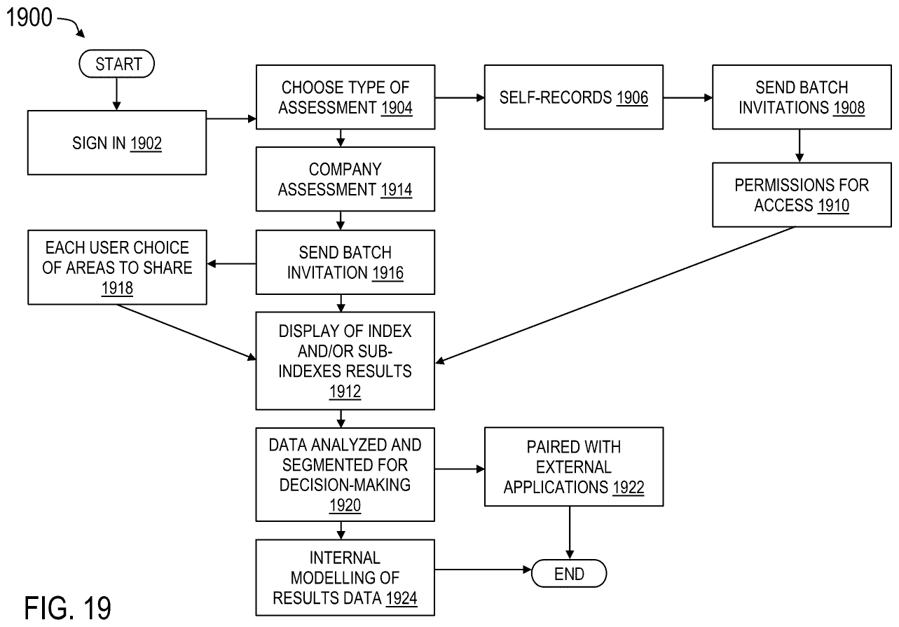

Referring to FIG. 19, the system may facilitate corporate wellness assessments for an employer user 1900. In step 1904, the employer may choose an assessment type. If a Corporate Assessment 1914 is selected, the system may initiate a batch invitation process 1916 to employees. The system processor 287 may allow recipients to exercise privacy control 1918 by selecting which specific financial health results to share. In step 1920, the system may aggregate and/or anonymize these results to provide the employer with segmented data for decision-making. This may allow the organization to assess workforce financial health without accessing sensitive individual data.

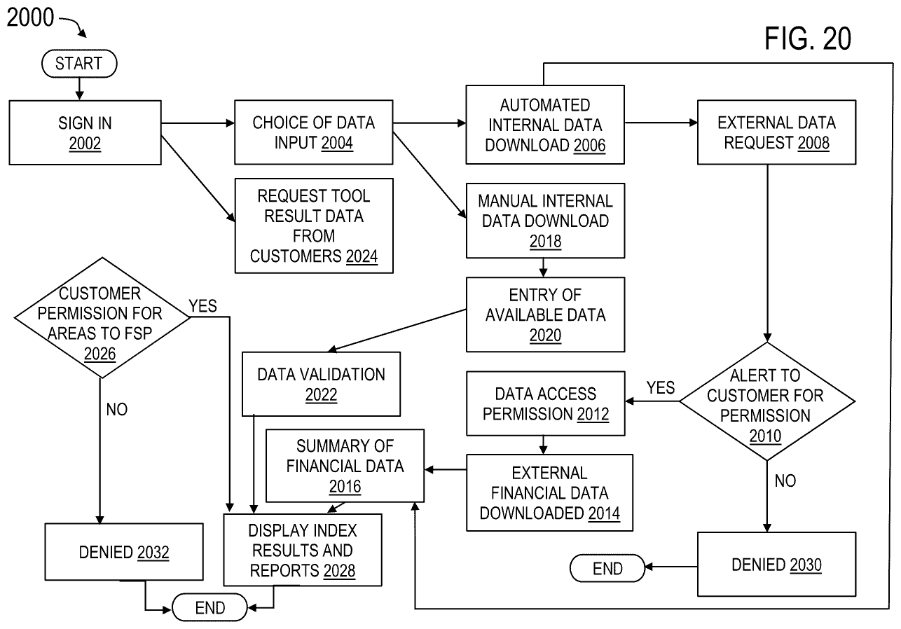

Referring to FIG. 20, the system may provide a specialized flow for financial service providers (FSP) 2000 for credit risk management. In step 2008, the FSP may request permission from a customer to access specific financial data and/or index results. The system may transmit an alert to the customer for permission 2010. If the customer grants authorization 2012, the system may automatically extract the approved data 2014, perform data validation 2022, and/or generate a risk assessment report 2028. If the customer denies the request, the process may be terminated at step 2030 or 2032. The system may allow FSPs to set real-time alerts for the duration of a loan product. This active monitoring may allow the FSP to identify potential financial stressors before a default occurs.

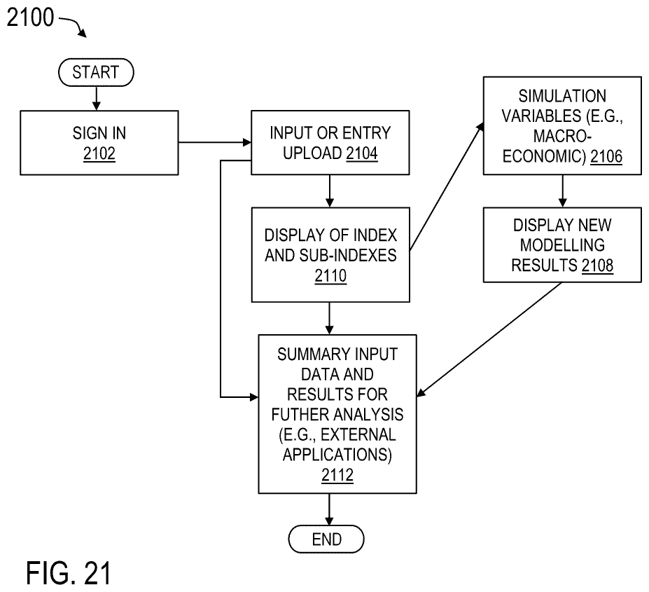

Referring to FIG. 21, the system may allow researchers to perform high-volume analysis 2100. In step 2104, the user may import data in batch mode, such as population datasets. The system processor 287 may generate a plurality of Personal Financial Health Indexes 1302 simultaneously. In step 2106, the researcher may run simulations by adjusting macro-economic variables, such as testing the impact of a 2% inflation hike on population health. The results may be made available in step 2112 for export to external statistical applications. This may facilitate global policy debate and/or economic research.

Referring to FIG. 11, the system may include a module 1100 for comparative statistics. This feature may allow individual users 1102-1108 to benchmark their Personal Financial Health Index 446 against aggregated averages. The system processor 287 may filter these comparisons by Demographics 1110, Socio-Economic Groups 1114, and/or Geographic/Regional Settings 1116. This context may help users understand their standing relative to peers.

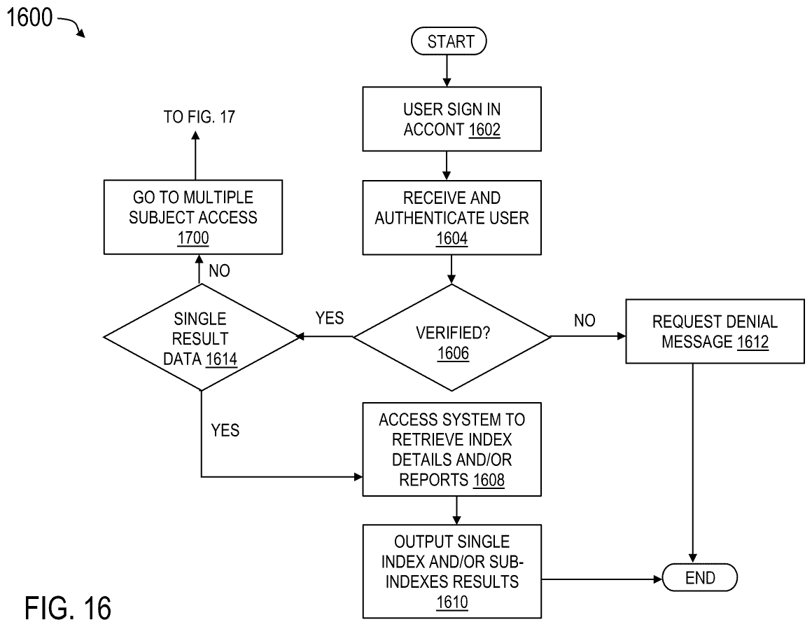

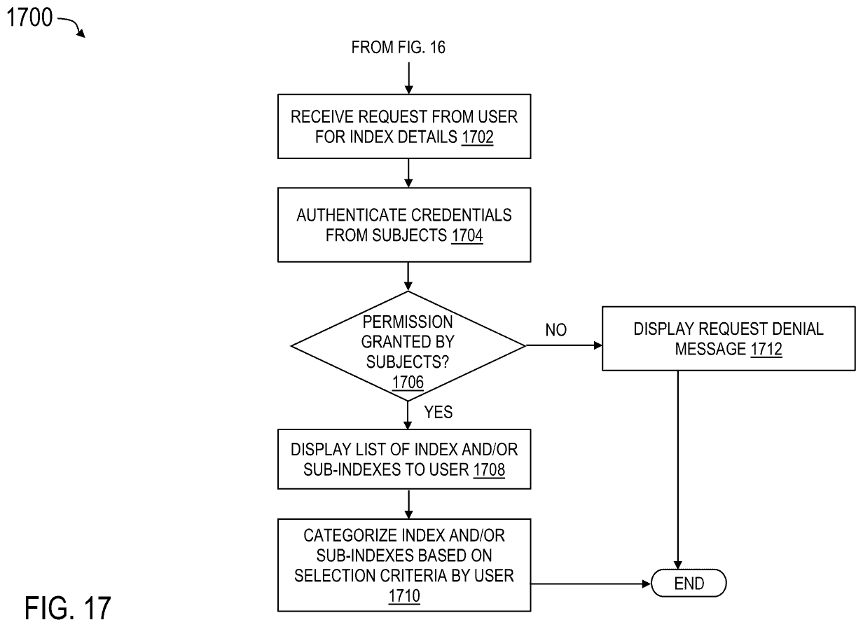

Referring to FIG. 16, the system may distinguish between access protocols. The Single Subject Access 1600 protocol may be utilized when a user requests data for a single individual. In step 1604, the system may authenticate credentials, and/or upon verification 1608, may display the index and/or sub-indexes 1610. Conversely, referring to FIG. 17, the Multiple Subject Access 1700 protocol may be utilized for batch requests, such as by lenders and/or researchers. In step 1702, the system may receive request from a user for index details and/or transmit alerts to all subject users. In step 1706, the system may verify permissions from each subject. If permission is denied by specific subjects, their data may be encrypted and/or locked so that they may be excluded from the final aggregated results.

The present disclosure may also be embodied as a non-transitory computer-readable medium, having stored thereon a program executable by a processor for performing at least one method as described herein.

Although the invention has been explained in relation to its preferred embodiment, it is to be understood that many other possible modifications and variations can be made without departing from the spirit and scope of the invention.

What is claimed is:

1. A computer system for generating a personal financial health index for a user, the system comprising:
a processor; and
a memory in communication with the processor, the memory storing a plurality of instructions that when executed by the processor, cause the system to:
receive a selection of a country and a choice of data input entry mode from a user;
populate an internal data repository with a set of financial data associated with the user, wherein the set of financial data is aggregated and categorized into a plurality of input categories comprising at least an income, a spending, a debt repayment, and an asset;
modify a plurality of values within the categorized financial data to resolve at least one computational error including identifying a denominator variable having a value of zero and transforming the denominator value by adding a non-zero integer and a rate of adjustment value;
adjust the modified financial data based on a plurality of country-specific variables associated with the selected country to reflect a socio-economic environment;
calculate a plurality of factor inputs by matching the adjusted financial data against one another, the plurality of factor inputs including at least a savings indicator, a solvency indicator, a protection indicator, a future indicator, and a liquidity indicator, wherein calculating the plurality of factor inputs includes performing advanced modeling to isolate at least one input variable;
generate a plurality of dynamic weights for the user by modelling interactions and interrelationships between the plurality of input categories and determining deviation values of the plurality of factor inputs from a plurality of pre-set standard benchmarks;
combine the plurality of factor inputs and the plurality of dynamic weights to determine a personal financial health index;
determine a plurality of sub-indexes corresponding to the plurality of factor inputs; and
transmit the personal financial health index and the plurality of sub-indexes to a user device for display.

2. The computer system of claim 1, wherein the modification of a plurality of values within the categorized financial data to resolve at least one computational error includes applying a zero denominator adjustment transformation described by a relation (X(n)+r)/(Y(n)+r), where X represents a numerator, Y represents a denominator having a value of zero, n represents a non-zero whole number, and r represents a rate of adjustment in a currency unit.

3. The computer system of claim 2, wherein the choice of data input entry mode comprises an automated entry mode via an Application Programming Interface configured to extract data from a server of a financial institution, and a manual entry mode utilizing an input building tool to aggregate a plurality of values entered by the user; where the processor is further configured to validate the set of financial data by matching the plurality of values entered by the user against a set of pre-populated market data and a plurality of public records, and determining a behavior rating by quantifying a deviation between the plurality of values entered by the user and the plurality of public records.

4. The computer system of claim 3, wherein the determination of the plurality of deviation values includes establishing an upper limit and a lower limit based on the plurality of pre-set standard benchmarks and computing a value based on the position of the calculated plurality of factor inputs relative to the upper limit and the lower limit.

5. The computer system of claim 1, wherein the adjustment of the upper value and the lower value to resolve at least one computational error comprises transforming a zero-value denominator into a non-zero whole number and applying a rate of adjustment to generate a probabilistic scale indicating a degree of intensity for the plurality of factor inputs.

6. The computer system of claim 5, wherein the plurality of country-specific variables includes at least one of an inflation rate, an interest rate, an unemployment rate, a gross domestic product, and a life expectancy rate associated with the country.

7. The computer system of claim 6, wherein the plurality of instructions further causes the system to generate an internal credit access score by modelling a plurality of variables comprising an employment history, a housing history, a credit provision, and the aggregated financial data.

8. The computer system of claim 5, wherein the instructions further cause the system to generate a plurality of sub-indexes corresponding to the plurality of factor inputs, the plurality of sub-indexes comprising at least a solvency sub-index, a savings potential sub-index, a future provision sub-index, and a credit access sub-index, and to display the plurality of sub-indexes alongside the personal financial health index.

9. A computer-implemented method for generating a personal financial health index for a user, the method comprising:
receiving, via a user interface, a selection of a country and a choice of data input entry mode from a user;
aggregating a set of financial data associated with the user into a plurality of input categories comprising at least an income, a spending, a debt repayment, and an asset;
modify a plurality of values within the categorized financial data to resolve at least one computational error including identifying a denominator variable having a value of zero and transforming the denominator value by adding a non-zero integer and a rate of adjustment value;
adjusting the financial data based on a plurality of country-specific variables associated with the selected country to reflect a socio-economic environment;
calculating a plurality of factor inputs by matching the adjusted financial data against one another, the plurality of factor inputs including at least a savings indicator, a solvency indicator, a protection indicator, a future indicator, and a liquidity indicator, wherein calculating the plurality of factor inputs includes performing advanced modeling to isolate at least one input variable;
generating a plurality of dynamic weights by modeling interactions between the plurality of input categories and determining a plurality of deviation values of the plurality of factor inputs from a plurality of pre-set standard benchmarks; combining the plurality of factor inputs and the plurality of dynamic weights to determine a personal financial health index;
determining a plurality of sub-indexes corresponding to the plurality of factor inputs; and
displaying the personal financial health index and the plurality of sub-indexes and a corresponding financial health status on a multimedia interface of a user device.

10. The method of claim 9, wherein calculating the plurality of factor inputs includes isolating a retirement savings value and adjusting the retirement savings value based on the country-specific variables including at least a life expectancy variable and a user demographic variable comprising age and generating an internal credit access score by modeling at least one variable selected from the group consisting of an employment history, a housing history, and the set of financial data.

11. The method of claim 9, wherein modelling interactions between the plurality of input categories comprises evaluating a relationship between at least a savings rate, a spending level, and an income level to determine a relationship value used in generating the plurality of dynamic weights.

12. The method of claim 11, wherein the determination of the plurality of deviation values comprises establishing an upper limit and a lower limit based on the plurality of pre-set standard benchmarks and computing a value based on the position of the calculated plurality of factor inputs relative to the upper limit and the lower limit.

13. The method of claim 12, further comprising: providing an estimated index factor based on the plurality of factor inputs; providing a projected index factor based on the plurality of pre-set standard benchmarks; and determining a personal financial health index by combining the estimated index factor and the projected index factor.

14. The method of claim 9, further comprising receiving a request for access to the personal financial health index from a third-party entity; and transmitting the personal financial health index upon receiving a permission authorization via the user interface.

15. A non-transitory computer-readable medium storing a plurality of instructions that, when executed by a processor, cause a computer system to perform operations comprising:
receiving a selection of a country and a choice of data input entry mode from a user;
populating an internal data repository with a set of financial data associated with the user, wherein the set of financial data is aggregated and categorized into a plurality of input categories comprising at least an income, a spending, a debt repayment, and an asset;
modify a plurality of values within the categorized financial data to resolve at least one computational error including identifying a denominator variable having a value of zero and transforming the denominator value by adding a non-zero integer and a rate of adjustment value;
adjusting the modified financial data based on a plurality of country-specific variables associated with the selected country to reflect a socio-economic environment;
calculating a plurality of factor inputs by matching the adjusted financial data against one another, the plurality of factor inputs including at least a savings indicator, a solvency indicator, a protection indicator, a future indicator, and a liquidity indicator, wherein calculating the plurality of factor inputs includes performing advanced modeling to isolate at least one input variable;
generating a plurality of dynamic weights for the user by modelling interactions between the plurality of input categories and determining a plurality of deviation values of the plurality of factor inputs from a plurality of pre-set standard benchmarks;
combining the plurality of factor inputs and the plurality of dynamic weights to determine a personal financial health index;
determining a plurality of sub-indexes corresponding to the plurality of factor inputs; and
transmitting the personal financial health index and the plurality of sub-indexes to a user device for display via a multimedia interface.

16. The non-transitory computer-readable medium of claim 15, wherein the plurality of instructions further cause the computer system to generate a real-time alert transmitted to the user device when a change in the plurality of country-specific variables impacts the personal financial health index.

17. The non-transitory computer-readable medium of claim 16, wherein the plurality of instructions further cause the computer system to generate a behavior rating by comparing a user response to a security question against the populated set of financial data and quantifying a deviation between the user response and the populated set of financial data.

18. The non-transitory computer-readable medium of claim 15, wherein the plurality of instructions further cause the computer system to run at least one simulation on the set of financial data using a plurality of pre-set macro-economic variables to project a future personal financial health index.

19. The non-transitory computer-readable medium of claim 18, wherein the plurality of instructions further cause the computer system to store a plurality of historical indexes and display a graphical representation of a change in the personal financial health index over a selected time period.

20. The non-transitory computer-readable medium of claim 19, wherein the plurality of instructions cause the personal financial health index to be displayed as a status classification selected from a group consisting of very low, low, average, high, and very high.
